(19) United States
(12) Patent Application Publication
(10) Pub. No.: US 2006/0261515 A1
(43) Pub. Date: Nov. 23, 2006

(54) Method for manufacturing a work piece using in-mold coating and melt compression molding

(76) Inventors: Robert S. Sevigny, Athens, TN (US); Laurent R. Gaudreau, North Berwick, ME (US); Lee Hodson, Rye Beach, NH (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 10/540,354

(22) PCT Filed: Dec. 18, 2003
(86) PCT No.: PCT/US03/40684

§ 371 Date: Jun. 23, 2005

Related U.S. Application Data
(60) Provisional application No. 60/436,868, filed on Dec. 27, 2002.

(51) Int. Cl. B29C 45/14

(52) U.S. Cl. 264/259

(57) ABSTRACT

The invention is a method of producing a melt compression molded work piece (18) includes the steps of introducing an in-mold coating (19) onto a first mold half (12) of a mold tool (10), and introducing a work piece material (17) onto a second mold half (14) of the mold tool. The work piece material has a temperature at or above a temperature at which at least a portion of the work piece material is in a molten state. The mold is then opened and the work piece (18) is removed after the work piece material has at least partially cooled.

### TECHNICAL FIELD

The present invention relates to a method for coating a work piece. More particularly, the present invention relates to a method for manufacturing a work piece using in-mold coating and a low pressure melt compression molding process.

### BACKGROUND OF THE INVENTION

Molded thermoplastic work pieces may need to be coated to facilitate paint adhesion, or to satisfy other surface property requirements. Unfortunately, the melt compression molding (MCM) process or its derivative cannot be employed to Class “A” surfaces because of the unsightly appearance caused by the flow lines produced when compressing the plastic log or billet during the extruding process. A coverstock material, such as Acrylnitrile-Butadien-Styrene-Copolymer (ABS), Polyvinyl-Choride (PVC), or various polyolefins is generally employed to “mask” these flow lines. However, the coverstock material may get deformed by the compression and heat of the extruded material and/or the MCM tool, thereby eliminating the advantages of covering the “A” surface. Even if the coverstock has a foam backing, as commonly used by those skilled in the art, the compression and heat of the MCM tool is such that the foam backed coverstock may still be deformed. Further, the addition of this coverstock significantly increases the cost of the resulting product, without guaranteeing the quality of the “A” surface, thereby making it uncompetitive with conventional injection molded products even when they are subsequently post painted.

### SUMMARY OF THE INVENTION

To solve these and other problems associated with the manufacture of molded thermoplastic work pieces, the inventor of the present invention has developed a method for manufacturing a work piece having an in-mold coating by a mold tool defined by a first mold half and a second mold half, comprising the steps of:
introducing an in-mold coating onto a first mold half of a mold tool;
introducing a work piece material onto a second mold half of the mold tool, the work piece material having a temperature at or above a temperature at which at least a portion of the work piece material is in a molten state;
closing the mold tool; and
opening the mold tool and removing the work piece after the in-mold coating and the work piece material have at least partially cooled.

### BRIEF DESCRIPTION OF THE DRAWINGS

FIG. 1 is a perspective view of the upper mold tool and spray gun according to one embodiment of the invention;

FIG. 2 is a perspective view of the melt compression mold (MCM) tool in an open position according to one embodiment of the invention;

FIG. 3 is a perspective view of the MCM tool in a partially closed position according to one embodiment of the invention;

FIG. 4 is a side view of an alternate low-pressure mold tool in an open position according to one embodiment of the invention.

### DESCRIPTION OF THE PREFERRED EMBODIMENT

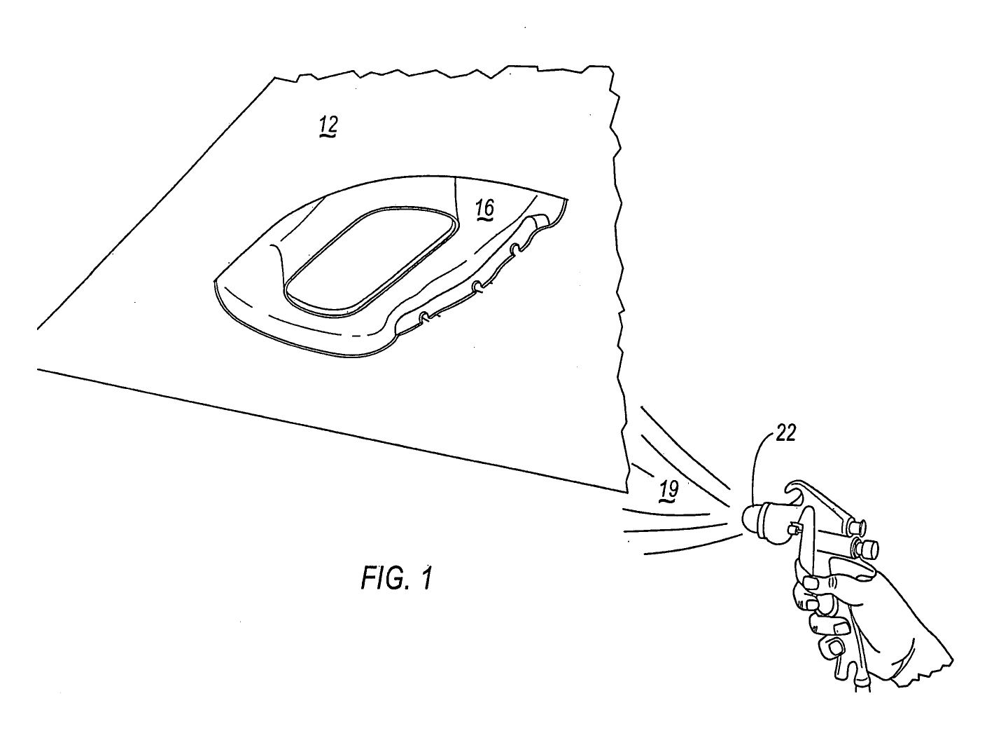

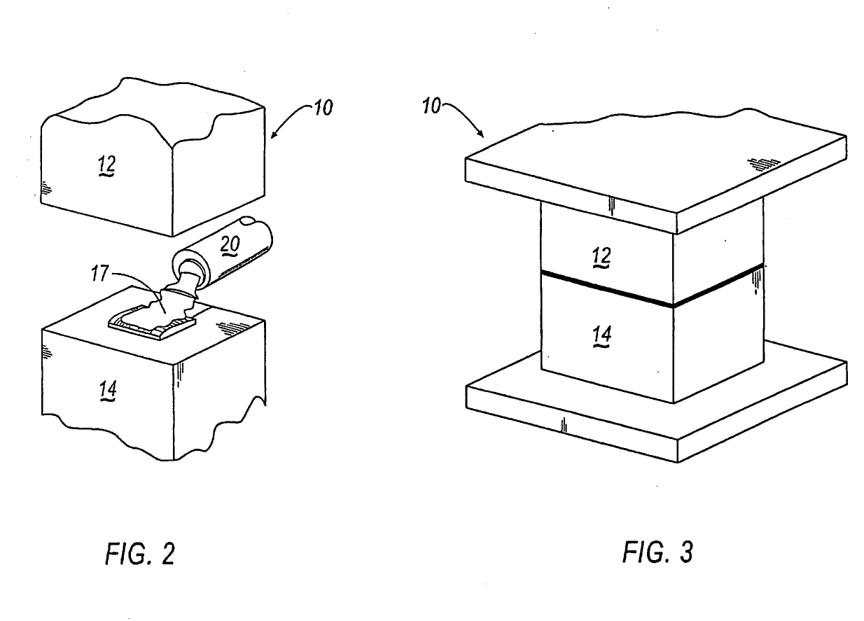

Referring to FIGS. 1-3, a melt compression mold tool 10 is generally shown. The melt compression mold (MCM) tool 10 comprises of an upper mold tool 12 and a lower mold tool 14. The upper mold tool 12 defines a cavity 16 having a desired contour that forms the shape of a work piece (Not shown). As described in more detail below, the work piece 18 is integrally formed with an in-mold coating (IMC) 19 in a single operation within the MCM tool 10. The MCM process permits the IMC 19 to be integrally bonded with the work piece 18 under low pressure operating conditions, thereby providing a simpler and more cost-effective method of manufacturing the work piece 18, as compared to products with coverstock materials.

The process of the present invention utilizes IMC 19, which are commercially available. The IMC 19 is sprayed on the surface of the cavity 16 of the upper mold tool 12 with a spray gun 21. The surface of the cavity 16 forms the class “A” surface of the work piece 18. In the illustrated process, the spray gun 21 is an airless gun that utilizes a high pressure, hydraulic system. As the IMC 19 passes through a nozzle 22 of the spray gun 21, the IMC 19 is atomized. However, the process of the present invention may be practiced with other types of spray guns known in the art, including air atomized spray guns. The IMC may be manually or robotically applied.

The IMC 19 is sprayed uniformly across the surface of the cavity 16 of the upper mold tool 16. However, it can be appreciated that the IMC 19 does not have to be uniformly sprayed. A combination of processes can be employed, such as molding a conventional coverstock (not shown) on an upper portion of the work piece 18 while employing the IMC 19 on a second portion of the work piece 18. Alternatively, two tone effects (not shown) can be generated by masking the work piece 18 and spraying two different types of IMC 19 on the work piece 18. Additionally, visual effects, such as “cloud printing” metallics, can be achieved by using the proper IMC 19 or application process, as commonly known in the art.

A mold release (not shown), as commonly known in the art, may be employed in the melt compression mold process. In the present process, the mold release is applied to the surface of the upper mold tool 12 and the lower mold tool 14 to assist in the removal of the work piece 18 at the completion of the melt compression mold process. One example of a mold release that can be applied directly to the upper and lower mold tool 12, 14 is polytetrafluoroethylene, more commonly known by the trade name of TEFLON®. However, the mold release does not have to be applied directly to the upper mold tool 12 and lower mold tool 14. Mold release agents can be formulated into the IMC 19 and sprayed onto the upper mold tool 12 and lower mold tool 14. The application of the mold release depends upon the characteristics of the IMC 19, the material of the work piece 18 and the surface of the upper mold tool 12 and lower mold tool 14.

Once the mold release is applied if desired, and the IMC 19 is sprayed onto the upper mold tool 12, the molding process is initiated. The molten work piece material 17 is extruded with an extruder head 20 by laying a ribbon of molten substrate material 17 into the MCM tool 10. The molten work piece material 17 may be any desirable thermoplastic resin material, such as, for example, Polypropylene (PP) or Thermoplastic Olefin (TPO). However, the invention is not limited by the properties of the molten work piece material 17, and that the invention can be practiced with a molten work piece material 17 with any suitable properties that will allow the molten work piece material 17 to bond with the IMC 19 and fill the cavity 16 of the lower mold tool 14. The thermoplastic material may be neat, filled with materials such as talc or reinforced with materials such as glass fibers. The thermoplastic resin material is deposited at a temperature above its melt point in order to permit adequate flow out upon the mold closing but not so high as to cause any degradation of the material.

Then, the MCM tool 10 is partially closed under low-pressure operating conditions so that the molten work piece material 17 fills the cavity 16 of the lower mold tool 14. As used herein, low pressure operating conditions is defined as the upper mold tool 12 and the lower mold tool 14 being moved to a closed position to exert a pressure of approximately 0.5 to 2.0 tons per square inch. Specifically, the upper mold tool 12 and the lower mold tool 14 are closed to exert a pressure such that the molten work piece material 17 is properly spread to conform to the cavity 16 within the lower mold tool 14. The amount of pressure depends on the configuration of the work piece 18 and the viscosity of the thermoplastic material such that the molten work piece material 17 may be properly spread. It will be appreciated that the invention is not limited by the pressure exerted by the upper and lower mold tools 12, 14 and that the invention can be practiced with any desirable pressure in which the molten work piece material 17 can be properly spread to conform to the cavity 16 when the MCM tool is closed.

The molten work piece material 17 then bonds with the IMC 19 under the low-pressure operating conditions of one cycling operation. As used herein, one cycling operation is defined as the closing of the MCM tool 10 from an open position, followed by the opening of the MCM tool 10 from the closed position. The amount of time necessary for the molten work piece material 17 to cure into the work piece 18 will depend on the property of the molten work piece material 17, the tool temperature, and the thickness of the work piece 18. It will be appreciate that the invention is not limited by the amount of time necessary for the molten work piece material 17 to bond to the IMC 19, and the invention can be practiced with any desired amount of time to complete one cycling operation.

At the end of the cycling operation, the cycling of the MCM tool 10 may be paused for a predetermined period of time so that the molten work piece material 17 may cool. The predetermined period of time for cooling the molten work piece material 17 may be, for example, approximately 30 to 40 seconds. Once the molten work piece material 17 is cooled, the molten work piece material 17 hardens to form the work piece 18 and the MCM tool 10 can be opened to allow the work piece 18 to be ejected or manually removed.

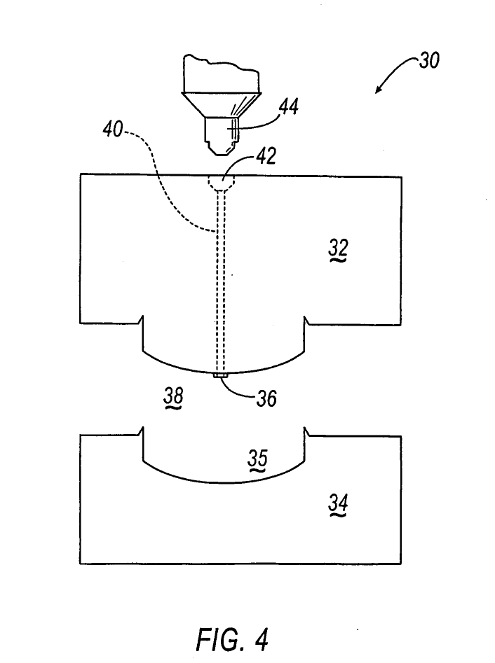

An alternate low-pressure molding process substantially incorporates most of the similar steps described in the above process. Referring to FIG. 4, a work piece 18 with an IMC 19 is molded under low-pressure operating conditions by using a low-pressure mold tool 30. The low-pressure mold tool 30 is defined by an upper mold half 32 and a lower mold half 34. A heated, low vestige, nozzle tip 36 of a gate 38, which is located on the upper mold half 32, injects the molten substrate material 17. In the illustrated embodiment, the nozzle tip 36 has a diameter of approximately 25 mm. The upper mold half 32 further includes a heated runner 40 and a sprue 42, which cooperates with an injector head 44 to introduce the molten work piece material 17 into the partially closed low-pressure mold tool 30. The lower mold half 34 defines a cavity 35 having a desired contour that forms the shape of the work piece 18.

The molten work piece material 17 for the low-pressure mold tool 30 may be any desirable thermoplastic resin, such as, for example, Polypropylene (PP), Acrylnitril-Butadiene-Styrene-Copolymer (ABS), Polycarbonate-Acrylnitrile-Butadiene-Styrene-Copolymer (PC/ABS), or Thermoplastic Olefin (TPO). However, it will be appreciated that the present invention is not limited by the properties of the molten work piece material 17, and that the invention can be practiced with a molten work piece material 17 with any suitable properties that will allow the molten work piece material 17 to bond with the IMC 19 and fill the cavity 35 of the lower mold half 34. The molten work piece material 17 is extruded through the injector head 44 into the low-pressure mold tool 30. The molten work piece material 17 may be injected prior to, during, or after the partial closing of the low-pressure mold tool 30. Preferably, the molten substrate material 17 is injected prior to or during the partial closing of the low-pressure mold tool 30.

It should be understood that the aforementioned and other various alternatives to the embodiments of the invention described herein may be employed in practicing the invention. It is intended that the following claims define the scope of the invention and that the method and apparatus within the scope of these claims and their equivalents be covered thereby.

1. A method for manufacturing a work piece by using in-mold coating and melt compression molding, the method comprising the steps of:
introducing an in-mold coating comprising a water-based or a solvent-based paint onto a first mold half of a mold tool;
introducing a work piece material onto a second mold half of the mold tool, the work piece material having a temperature at or above a temperature at which at least a portion of the work piece material is in a molten state;
closing the mold tool; and
opening the mold tool and removing the work piece after the work piece material has at least partially cooled.

2. A method for manufacturing a work piece according to claim 1, wherein the in-mold coating is introduced by spraying the in-mold coating onto the first mold half.

3. A method for manufacturing a work piece according to claim 1, wherein the work piece material comprises a thermoplastic resin material.

4. A method for manufacturing a work piece according to claim 3, wherein the material comprises Polypropylene (PP), Acrylnitril-Butadiene-Styrene-Copolymer (ABS), Polycarbonate-Acrylnitril-Butadien-Styrol-Copolymer (PC/ABS), or Thermoplastic Olefin (TPO) material.

5. A method for manufacturing a work piece according to claim 1, wherein the work piece material includes fillers, reinforcement glass or reinforcement natural fibers.

6. A method for manufacturing a work piece according to claim 1, further including the step of introducing a mold release onto one of the first or second mold tool halves.

7. A method for manufacturing a work piece according to claim 1, wherein the in-mold coating comprises a polyurethane paint.

8. A method for manufacturing a work piece according to claim 1, wherein the in-mold coating has a thickness in a range between about 10-50μ.

9. A method for manufacturing a work piece according to claim 1, wherein the closed mold tool exerts a pressure of approximately 0.5 to 2.0 tons per square inch.
